(19) United States
(12) Patent Application Publication
(10) Pub. No.: US 2017/0230826 A1
(43) Pub. Date: Aug. 10, 2017

(54) AUTHENTICATION IN A RADIO ACCESS NETWORK

(71) Applicant: TELEFONAKTIEBOLAGET LM ERICSSON (PUBL), Stockholm (SE)

(72) Inventors: Filip MESTANOV, SOLLENTUNA (SE); Tomas HEDBERG, Stockholm (SE); Karl NORRMAN, Stockholm (SE); Oumer TEYEB, Solna (SE); Jari VIKBERG, Järna (SE)

(73) Assignee: TELEFONAKTIEBOLAGET LM ERICSSON (PUBL), Stockholm (SE)

(21) Appl. No.: 15/329,479

(22) PCT Filed: Jul. 28, 2014
(86) PCT No.: PCT/EP2014/066198

§ 371 Date: Jan. 26, 2017

(51) Int. Cl. H04W 12/06; H04W 36/00; H04L 9/08; H04L 9/14; H04L 29/06; H04W 12/04

(52) U.S. Cl. CPC H04W 12/06; H04L 63/0892; H04L 63/06; H04W 12/04; H04L 63/083; H04L 9/0838; H04L 63/0876; H04L 9/0894; H04L 9/14; H04W 36/0038; H04W 84/12

(57) ABSTRACT

A method and apparatus for authenticating a mobile device in a second mobile access network when the mobile device is already authenticated in a first mobile access network. An access device receives an authentication request from the mobile device. The access device obtains secondary authentication information derived from primary authentication information used in an authentication procedure to authenticate the mobile device with the first mobile access network. The access device then uses the secondary authentication information to authenticate the mobile device in the second mobile access network. An advantage of this method is that authentication credentials can be re-used to a certain extent to improve the speed of authentication in the second network and reduce the amount of signalling and processing required to authenticate the mobile device in the second network.

### TECHNICAL FIELD

The invention relates to the field of authentication in a Radio Access Network, such as authentication in a Wireless Local Area Network of a device that has already been authenticated in another type of Radio Access Network.

### BACKGROUND

There is currently a drive to use Wi-Fi access networks to off-load signalling load from a 3GPP network. For example, a Radio Base Station (RBS) may provide 3GPP services within a certain area A. Within that area A, one of more Wi-Fi totspots' may be provided by Wi-Fi Access Points (APs), each of which allows Wi-Fi access to a communications network for a mobile client device such as a User Equipment (UE). Note that the same device is termed a UE in the context of a 3GPP network, and a Station (STA) in the context of a Wireless Local Area Network (WLAN). The UE therefore can choose to access a communications network via 3GPP, Wi-Fi or both. In the following description, the term UE is used. It will be understood that a UE accessing a WLAN may be termed a Station.

UEs that are both 3GPP capable and Wi-Fi capable can use either type of access. If a UE is capable of accessing a Wi-Fi AP, and such accessing is enabled, the UE will typically automatically connect to a (known) Wi-Fi network as soon as the UE detects the Wi-Fi network. The UE may maintain its 3GPP registration for services such as voice and short message service (SMS), but may exclusively use the Wi-Fi access network for packet data.

When a UE attaches to a WLAN network, an authentication procedure is followed, as described for example in RFC 4186 for the EAP-SIM case. In brief, the UE communicates with an AP in order to be authenticated. The AP determines the UE identity (for example, a permanent UE identity such as an International Mobile Subscriber Identity, IMSI, or a temporary UE identity such as a pseudonym). The AP contacts an Authentication, Authorization and Accounting (AAA) server (at least partly based on the UE identity) which initiates an EAP-SIM procedure. This involves sending an EAP-Request/SIM/Start to the UE via the AP indicating that EAP-SIM authentication is initiated. The UE responds with a random number (NONCE_MT) and other parameters to the AAA in EAP-Response/SIM/Start. The AAA obtains a GSM triplet (RAND, SRES, Kc) from a Home Location Register (HLR) or Authentication Centre (AuC) and derives keying material, as described in Chapter 7 of RFC 4186. The AAA generates an EAP-Request/SIM/Challenge message that includes a RAND value and a first message authentication code attribute AT_MAC. The first AT_MAC is derived from the RAND and Kc values. The EAP-Request/SIM/Challenge message is sent to the UE, which uses the received RAND value to determine a second AT_MAC and a SRES value. If the second AT_MAC value derived at the UE matches the first AT_MAC value derived by the AAA server, then authentication can proceed. The UE generates a third AT_MAC based on the SRES and this is sent to the AAA server in an EAP-Response/SIM/Challenge message. Once the AAA server verifies the third AT_MAC derived by the UE, it sends an EAP-Success message to the AP that also includes keying materials in the form of a Pairwise Master Key (PMK). The PMK is not sent to the UE, but stored at the AP. Note that PMK can also be derived by the UE as it is based on Kc.

The AP uses the PMK to generate an Authenticator nonce (ANonce), which is sent to the UE. The UE uses the ANonce along with a Supplicant nonce (SNonce) and the PMK to generate a Pairwise Temporal Key (PTK). The SNonce is sent to the AP which also constructs the PTK, and in addition generates a Group Temporal Key (GTK). The GTK is sent to the UE along with an instruction to install the PTK. The UE then installs the PTK and the GTK, and uses these two keys to encrypt and decrypt all communication sent via the AP.

IEEE 802.11r introduces a fast transition management to support handovers between APs that are part of the same mobility domain. This means that a new authentication procedure need not be followed when the UE attaches to a new AP; instead, only a fresh PTK is derived.

Turning now to 3GPP access networks, a UE is authenticated using an Authentication and Key Agreement (AKA) protocol. The AKA protocol results in the UE and a Mobility Management Entity (MME) being mutually authenticated and sharing a session key termed K_{ASME}.

The UE initiates the procedure by sending an attach request to the MME. The message contains the identity of the UE, the IMSI (or a temporary identity that the MME can map to the IMSI). The MME requests an authentication vector (AV) for the UE from a Home Subscriber Server (HSS). The HSS replies with an AV. The AV contains a random challenge RAND, the expected result to the challenge XRES, an authentication token AUTN, and a session key K_{ASME}. The MME sends the RAND and AUTN to the UE, which computes a response to the RAND using the USIM. The result is called RES. The UE also verifies the network authenticity and RAND freshness by verifying the AUTN, again using the USIM. If the verification passes, the UE sends the response RES back to the MME. The MME verifies that the RES matches the XRES. If they match, the UE is considered authenticated and the MME starts Non-Access Stratum (NAS) security based on K_{ASME} by running the security mode procedure. The UE calculates K_{ASME} from the RAND using the USIM and starts NAS security based on that K_{ASME}. The MME sends an attach accept to the UE to complete the attach procedure.

When a UE establishes a connection to the EPS core network via a non-3GPP access, it performs an EAP-AKA or EAP-AKA′ authentication similar to that described above (and with some similarities to the described EAP-SIM procedure). There is no concept of handover between the two types of access, but connections are established and torn down independently. Note that access to the EPS core network is only allowed if the UE is equipped with a USIM so that the UE can run EAP-AKA(′). A session key is established as a result of the authentication.

Two functions are provided for the maintenance of security between the UE and an eNB: ciphering of both control plane (RRC) data (i.e. SRBs 1 and 2) and user plane data (i.e. all DRBs), and integrity protection which is used for control plane (RRC) data only. Ciphering is used in order to protect data streams from being received by a third party, while integrity protection allows the receiver to detect packet insertion or replacement. RRC always activates both functions together, either following connection establishment or as part of the handover to LTE. The process is based on a common secret key K_{ASME} which is available only in the Authentication Centre in the HSS and in a secure part of the Universal Subscriber Identity Module (USIM) in the UE.

A set of keys and checksums are generated at the Authentication Centre using this secret key and a random number. The generated keys, checksums and random number are transferred to the MME, which passes one of the generated checksums and the random number to the UE. The USIM in the UE then computes the same set of keys using the random number and the secret key. Mutual authentication is performed by verifying the computed checksums in the UE and network using NAS protocols.

Upon connection establishment, the Access Stratum (AS), indicating communication between the UE and the eNB, derives an AS base-key K_{eNB}, which is eNodeB specific, from K_{ASME}. K_{eNB} is used to generate three further security keys known as the AS derived-keys: one for integrity protection of the RRC signalling (SRBs), one for ciphering of the RRC signalling and one for ciphering of user data (DRBs).

Regarding security during handover in LTE, the concept of forward security was introduced to ensure adequate security and minimize the risk of unauthorized access. Forward security means that without the knowledge of K_{ASME}, even with the knowledge of K_{eNB} (key shared between the UE and the current eNB), it will be computationally difficult to generate K_{eNB}s to be used between the UE and eNBs that the UE will connect to in the future.

Whenever an initial AS security context needs to be established between UE and eNB, the MME and the UE derive a K_{eNB} and a Next Hop parameter (NH). K_{eNB} and the NH are derived from K_{ASME}. A NH Chaining Counter (NCC) is associated with each K_{eNB} and NH parameter. Every K_{eNB} is associated with the NCC corresponding to the NH value from which it was derived. At initial setup, K_{eNB} is derived directly from K_{ASME}, and is then considered to be associated with a virtual NH parameter with NCC value equal to zero. At initial setup, the derived NH value is associated with the NCC value one.

The MME does not send the NH value to eNB at the initial connection setup. The eNB initializes the NCC value to zero after receiving an S1-AP Initial Context Setup Request message.

The UE and the eNB use K_{eNB} to secure the communication. On handover, the basis for the K_{eNB} that will be used between the UE and the target eNB, called K_{eNB}*, is derived from either the currently active K_{eNB} or from the NH parameter. If K_{eNB}* is derived from the currently active K_{eNB} this is referred to as a horizontal key derivation and if K_{eNB}* is derived from the NH parameter the derivation is referred to as a vertical key derivation. On handover with vertical key derivation, the NH is further bound to the target PCI and its frequency EARFCN-DL before it is taken into use as the K_{eNB} in the target eNB. On handover with horizontal key derivation the currently active KeNB is further bound to the target PCI and its frequency EARFCN-DL before it is taken into use as the K_{eNB} in the target eNB.

As NH parameters are only computable by the UE and the MME, it is arranged so that NH parameters are provided to eNBs from the MME in such a way that forward security can be achieved.

When a dual-mode (both WLAN and 3GPP capable) UE connects to a WLAN network (e.g., after being steered from a 3GPP network to a WLAN one, or connected to a WLAN network in addition to a 3GPP network), it uses an Extensible Authentication Protocol (EAP-SIM/AKA/AKA′) as an authentication method. Existing EAP procedures require that the UE always authenticates with a back-end AAA server. This procedure takes time and resources and involves exchanging several messages. This introduces delay between the point when the UE connects to the WLAN network and the time when the UE can start using the WLAN network for transporting traffic. Furthermore, for each authentication an authentication vector is required from the HSS. This puts an increased load on the HSS, which is often seen as a bottleneck.

### SUMMARY

It is an object to reduce the resources required when authenticating a mobile device moving from one Radio Access Network to another. This may be connecting to a second Radio Access Network instead of or in addition to the first Radio Access Network.

In the example where a mobile device hands over from a 3GPP network to a WLAN network, the use of EAP-SIM/AKA/AKA′ is avoided when authenticating the mobile device in the WLAN. This reduces authentication delay and core network authentication signalling.

Authentication is based on implicit authentication via a variation of security context transfer. The mobile device is considered authenticated in the target access network (e.g. WLAN) if it can provide evidence of that it already has authenticated in the source access network (e.g. 3GPP).

According to a first aspect, there is provided a method of authenticating a mobile device in a second mobile access network, when the mobile device is already authenticated in a first mobile access network. An access device receives an authentication request from the mobile device. The access device obtains secondary authentication information derived from primary authentication information used in an authentication procedure to authenticate the mobile device with the first mobile access network. The access device then uses the secondary authentication information to authenticate the mobile device in the second mobile access network. An advantage of this method is that authentication credentials can be re-used to a certain extent to improve the speed of authentication in the second network and reduce the amount of signalling and processing required to authenticate the mobile device in the second network.

As an option, the first mobile access network comprises a 3GPP network and the second mobile access network comprises a Wireless Local Area Network.

The access device is optionally an R0 Key Holder. The R0 Key Holder may be located in any of the first and second mobile access networks.

As a further option, the primary authentication information comprises a Pairwise Master Key. In this case, the method optionally comprises deriving a second Pairwise Master Key for use in authenticating the mobile device in the second mobile access network. As a further option, the second Pairwise Master Key is usable to derive a Pairwise Temporal Key, the Pairwise Temporal Key being usable by the mobile device to perform an encryption operation on communications sent between the mobile device and the second mobile access network.

The method optionally includes receiving, in the authentication request, information identifying the primary authentication information and determining the identity of a further access device from which the secondary authentication information can be obtained. In this case, the method optionally includes sending to the further access device the received information identifying the primary authentication information.

The identity of the further access device is determined optionally by any of querying a location function storing an identity of the further device using an identity of the mobile device, and receiving information identifying the primary authentication information in the authentication request identifying the further access control device.

As an option, the method further comprises performing authentication in the second mobile access network using a fast re-authentication procedure, for example the fast re-authentication procedure defined in IEEE 802.11r and described above.

According to a second aspect, there is provided an access device arranged to authenticate a mobile device in a network when the mobile device is already authenticated in a first mobile access network. The access device is provided with a receiver configured to receive an authentication request from the mobile device. A processor is configured to obtain secondary authentication information derived from primary authentication used in an authentication procedure to authenticate the mobile device with the first mobile access network. The processor is further configured to authenticate the mobile device in the network using the obtained secondary authentication information.

As an option, the first mobile access network comprises a 3GPP network and the network comprises a Wireless Local Area Network.

The access device is optionally an R0 Key Holder.

As an option, the primary authentication information comprises a Pairwise Master Key. In this case, the processor (12) is optionally further configured to derive a second Pairwise Master Key for use in authenticating the mobile device in the network.

The processor is optionally configured to determine from the authentication request information identifying the primary authentication information, and subsequently determine an identity location of a further access device from which the secondary authentication information can be obtained. The access device is optionally provided with a transmitter arranged to send to the further access device the received information identifying the primary authentication information. As a further option, the processor is further configured to determine the location of the further access control device by any of querying a location function storing an identity of the further device using an identity of the mobile device, and receiving information in the authentication request identifying the further access control device.

According to a third aspect, there is provided a mobile device for use in a communication network. The mobile device is provided with a receiver configured to receive information identifying primary authentication information used to authenticate the mobile device in a first mobile access network. The mobile device is also provided with a transmitter arranged to send a request to an access device to authenticate the mobile device in a second mobile access network. The request includes information identifying primary authentication information usable by the access device to derive secondary authentication information to authenticate the mobile device in the second mobile access network.

The mobile device optionally further comprises a processor arranged to, prior to sending the request to the access device, determine that the mobile device is authenticated in the first mobile access network and, as a result, send the request to authenticate the mobile device in the second mobile access network as a re-authentication request.

According to a fourth aspect, there is provided an access device for use in a first mobile access network with which a mobile device is authenticated. The access device comprises a first transmitter for, during an authentication procedure with the mobile device, sending to the mobile device information identifying primary authentication information. It is also provided with a receiver configured to receive from a further access device located in a second mobile access network a request for secondary authentication information, the request containing the information identifying primary authentication information. A processor is provided that is configured to derive the secondary authentication information using the primary authentication information. A second transmitter is also provided configured to send to the further access device the secondary authentication information usable by the further access device to authenticate the mobile device (1) in the second mobile access network.

According to a fifth aspect, there is provided a computer program comprising computer readable code which, when run on an access device, causes the access device to perform the method as described above in the first aspect.

According to a sixth aspect, there is provided a computer program comprising computer readable code which, when run on a mobile device, causes the mobile device to send a request to an access device to authenticate the mobile device in a second mobile access network, the request including information identifying primary authentication information used to authenticate the mobile device in a first mobile access network and usable by the access device to derive secondary authentication information to authenticate the mobile device in the second mobile access network.

According to a seventh aspect, there is provided a computer program comprising computer readable code which, when run on an access device in a first mobile access network with which a mobile device is authenticated, causes the access device to send to the mobile device information identifying primary authentication information and, in response to a request from a further access device in a second mobile access network, derive secondary authentication information using the primary authentication information and send to the further access device the derived secondary authentication information, the secondary authentication information usable by the further access device to authenticate the mobile device in the second mobile access network.

According to an eighth aspect, there is provided a computer program product comprising a non-transitory computer readable medium and the computer program described above in any of the fifth, sixth or seventh aspects, wherein the computer program is stored on the computer readable medium.

### BRIEF DESCRIPTION OF DRAWINGS

FIG. 1 illustrates schematically in a block diagram an exemplary network architecture showing two radio access devices;

FIG. 2 illustrates schematically in a block diagram an exemplary network architecture showing two radio access devices and an interface between the radio access devices;

FIG. 3 is a signalling diagram showing exemplary signalling on handover from a first radio access to a second radio access network;

FIG. 4 illustrates schematically in a block diagram an exemplary network architecture showing a single radio access device;

FIG. 5 is a signalling diagram showing exemplary signalling on handover from a first radio access network to a second radio access network using the network architecture of FIG. 4;

FIG. 6 is a flow diagram showing exemplary steps;

FIG. 7 illustrates schematically in a block diagram an exemplary access device arranged to authenticate a mobile device;

FIG. 8 illustrates schematically in a block diagram an exemplary mobile device; and

FIG. 9 illustrates schematically in a block diagram an exemplary access device arranged to authenticate a mobile device.

### DETAILED DESCRIPTION

The following description refers to a mobile device, which may be termed a UE or a STA depending on the type of access it is currently using. The terms first radio access network and second radio access network are also used. In the examples given, the first radio access network is a 3GPP radio access network and the second radio access network is a WLAN. It will be appreciated that different types of radio access network may also use similar procedures for authentication. The term “handover” is also used herein. However, it will be appreciated that in some cases, handover to a second radio access network may involve the mobile device being connected to the second radio access network in addition to the first radio access network, for example where a mobile device is capable of accessing both 3GPP and WLAN networks simultaneously.

In a first example, when a mobile device that is attached to a 3GPP network attempts to attach to a WLAN AP, instead of using the EAP-SIM/AKA/AKA′ authentication, the authentication information that the mobile device has already received in 3GPP can be reused. This is possible because both types of access rely on authentication vectors coming from the HSS. In that way, when the mobile device attaches to the WLAN network, it can re-establish only the over-the-air encryption keys and does not need to perform the authentication procedure with the HSS all over again. This greatly reduces the time and signalling required for authenticating the mobile device in the WLAN.

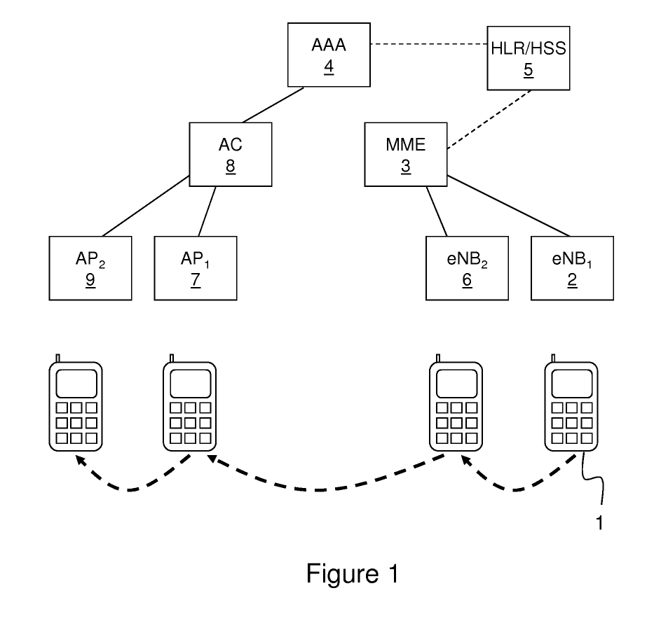

FIG. 1 shows an exemplary network topology. A mobile device 1 in this example is connected to a 3GPP network via a first eNodeB 2. The mobile device is therefore authenticated via a MME 3 in association with an HLR/HSS 5 using the procedures described above.

If the mobile device 1 performs a handover to a second eNB 6, there is no need to perform a full re-authentication as much of the required authentication material is already stored at the MME. However, the mobile device 1 may also connect to an AP 7, in which case a full authentication procedure would need to be performed via an Access Controller (AC) 8. In this case the AC 8 is the R0 key holder, and must derive and hold PMK-R0. Once the mobile device 1 is authenticated, the mobile device is the PTK key holder, which is derived by the R0 key holder. The first AP 7 is the R1 key holder, and derives a first PTK for use between the first AP 7 and the mobile device 1.

If the mobile device connects to a second AP 9, the AC 8 in its capacity as R0 key holder derives a PMK for use by the second AP 9. The second AP 9 derives a second PTK for use between the mobile device 1 and the second AP 9.

Mechanisms are provided to avoid a full re-authentication procedure being carried out when the mobile device 1 is already connected to a first network (e.g. attached to the second eNB 6) and then connects to a second network (e.g. attaches to AP 7). The mobile device may connect to the second network in addition to or instead of being connected to the first network.

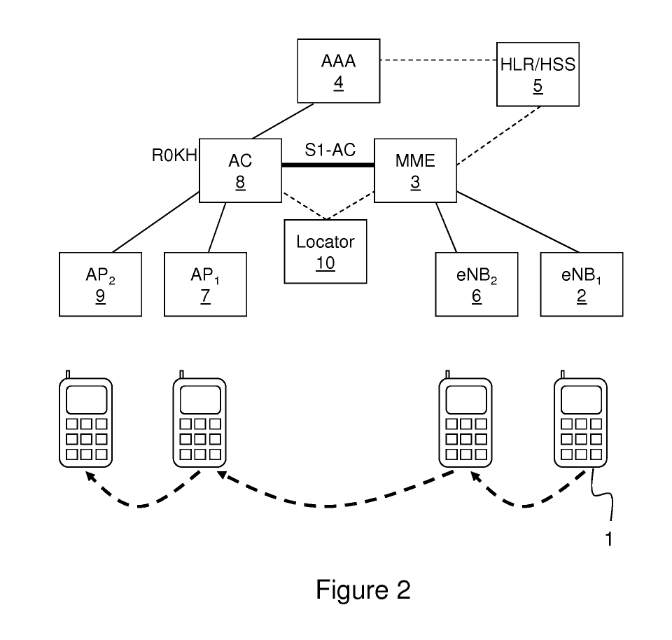

A first specific embodiment is illustrated in FIG. 2, in which an interface is introduced between two radio access devices. In this example, a first radio access device is the MME 3 and a second radio access device is the AC 8. The AC 8 is the R0 key holder. The interface allows the MME to calculate the PMK key and provide it to the R0 key holder, which means the R0 key holder does not need to fetch the key from the HSS (via the AAA). The R0 key holder can then generate appropriate PTKs for each AP 7, 9 (acting as R1 key holders). Note that the same concept can be used if the R0 key holder is not an AC, but an access device for another type of network.

In FIG. 2, the interface between the MME 3 and the AC 8 is termed an S1-AC interface. The S1-AC interface is used to transfer the PMK from the MME 3 to the R0 key holder 8 for each handing over mobile device 1. In order to establish the interface, the AC 8 and MME 3 must be able to discover each other. There are several ways in which discovery can be implemented.

A first example is to use a “Locator” function 10 in the network, as shown in FIG. 2. The locator function allows for an automatic discovery between the AC 8 and the MME 3. In this case, a new interface is included both between the MME 3 and the Locator function, and between the AC 8 and the Locator function 10. The MME 3 registers the mobile device 1 (identified by e.g. a permanent UE identity such as an IMSI or a temporary UE identity such as a SAE-Temporary Mobile Subscriber Identity (S-TMSI) or a Globally Unique Temporary UE Identity (GUTI), both described below) to the Locator function 10 when the mobile device 1 attaches to the MME 3 (or whenever such identities are reallocated). The MME 3 provides information about its own address as part of the registration to the Locator function 10. When the mobile device 1 attempts to access AP 7, the WLAN access may obtain either a permanent UE identity such as the IMSI or a temporary UE identity such as the S-TMSI or GUTI from the mobile device. Once the WLAN access network retrieves the UE identity, the AC 7 queries the Locator function 10 using this UE identity to retrieve the current MME 3 for the mobile device 1.

Alternatively, discovery may be implemented dynamically, in which case the Locator function shown in FIG. 2 is not required. The AC 8 discovers the MME based on information only supplied by the mobile device 1. This information may be explicit. For example, the mobile device 1 provides an identity of the MME 3 over WLAN messaging. Examples of the identity of the MME 3 include a Globally Unique Temporary UE Identity (GUTI) or an SAE-Temporary Mobile Subscriber Identity (5-TMSI) that are both used by legacy mobile devices 1. The GUTI uniquely identifies the MME that allocated the GUTI and contains the Globally Unique MME Identifier (GUMMED. GUMMEI contains PLMN-ID and an MME Identifier (MMEI). MMEI further contains both the MME Group ID (MMEGI) and an MME Code (MMEC). S-TMSI contains the MMEC as well. Therefore either the GUTI or the S-TMSI can be used to retrieve the MME transport identity by using a static database (for example a Domain Name System, DNS, database).

Alternatively, the information provided by the mobile device 1 may be implicit. For example, the AC 8 can derive the identity of the MME 3 to be used from information provided by the mobile device 1 in signalling messaging, such as a PMKR0Name. Using this parameter, the AC 8 can resolve the MME identity. One example is that the PMKR0Name is registered to the above described “Locator” function 10 i.e. an MME registers its PMKR0Name to the Locator 10 and the AC 8 retrieves the MME transport identity from the Locator function 10. Another example is to use a static database (for example a DNS database) to map between PMKR0Name and the MME identity.

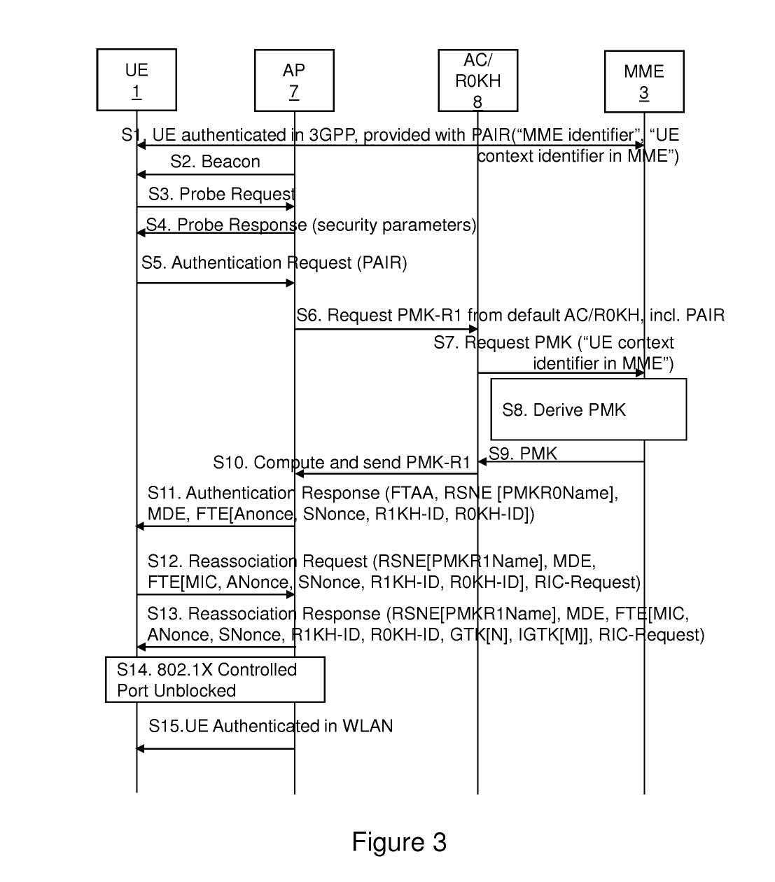

An exemplary signalling diagram showing authentication is shown in FIG. 3. The following numbering corresponds to that of FIG. 3.

51. The mobile device (termed UE in FIG. 3) 1 is authenticated in a 3GPP network and provided with information identifying primary authentication information (PAIR) used to authenticate the device in the 3GPP network. The PAIR comprises an MME identifier and a UE context identifier used in the MME. When the mobile device 1 is attached in the 3GPP network, the PMKR0Name is provided to the mobile device 1. A possible way to do that is making use of the Security Mode Command procedure, which can be executed at initial 3GPP Attach, but could also be invoked at a later point. Other options including the PMKR0Name in the Attach accept or authentication messages or in Tracking/Routing Area Accept messages. The last option has the advantage that in case the mobile device 1 moves into coverage of a new MME/SGSN, the new PMKR0Name will be assigned when that event happens. Further options are to include the PMKR0Name in RRC messages sent from the eNB to the STA (e.g., RRC Connection Setup). The eNB may have learnt the PMKR0Name for this STA from the MME/SGSN.

S2. The mobile device 1 receives a Beacon frame revealing (among other parameters) the security features associated with the BSS/ESS the AP 7 belongs to. The format of the beacon frame as well as all the information elements it carries are described in Chapter 8.3.3.2 of IEEE 802.11;

S3 If the mobile device 1 does not receive a Beacon frame for some reason, it can generate a Probe Request and send it to the AP 7. This procedure is called active scanning and by performing it, the mobile device 1 can receive from the AP 7 the same information as it would have from a Beacon message. The Probe Request frame is described in Chapter 8.3.3.9 of IEEE 802.11.

S4. The AP 7 answers with Probe Response.

S5 The mobile device 1 sends an Authentication Request to the target AP 7, the request including the PAIR.

S6. The AP 7 requests the PMK-R1 from the default R0KH and sends the PAIR. The R0KH is the AC 8. The AC 8 locates the correct MME using the MME identifier part of the PAIR.

S7. The R0KH 8 requests the PMK from the MME 3, including the UE context identifier used in the MME (part of PAIR). The PMK is identified by the UE context identifier in the MME 3 (again as informed by the mobile device 1 in step S5).

S8. The MME 3 derives the PMK using K_{ASME} and other parameters.

S9. The MME 3 sends the PMK to the R0KH 8.

S10. The R0KH 8 computes the PMK-R1 to be used and provides it to the AP 7.

S11. The AP 7 responds to the mobile device 1 with an Authentication Response, indicating the FTAA, the RSNE, the MDE and the FTE (which in this case carries also the Authentication Nonce, ANonce, and the R0KH-ID).

S12. The mobile device 1 re-associates with the target AP 7 within the allowed Re-association Deadline Time, sending a Re-association Request.

S13. The target AP 7 responds with Re-association Response.

S14. The 802.1X controlled port is unblocked and the mobile device 1 can successfully transmit (encrypted) data to the target AP 7.

S15. The mobile device 1 transmits data over the WLAN.

The MME generates the PMK from the K_{ASME} of the currently active EPS security context or from an inactive native EPS security context. The generation is done by applying a key derivation function to the K_{ASME}.

The above steps allow the mobile device 1 to be authenticated when attaching to AP 7 without the AC 8 having to contact the HSS/HLR 5 and undergo a full authentication procedure. The security materials used to authenticate with the MME 3 are re-used by the AC 8 so the PMK may be derived without needing to contact the AAA server or other back-end authentication mechanism.

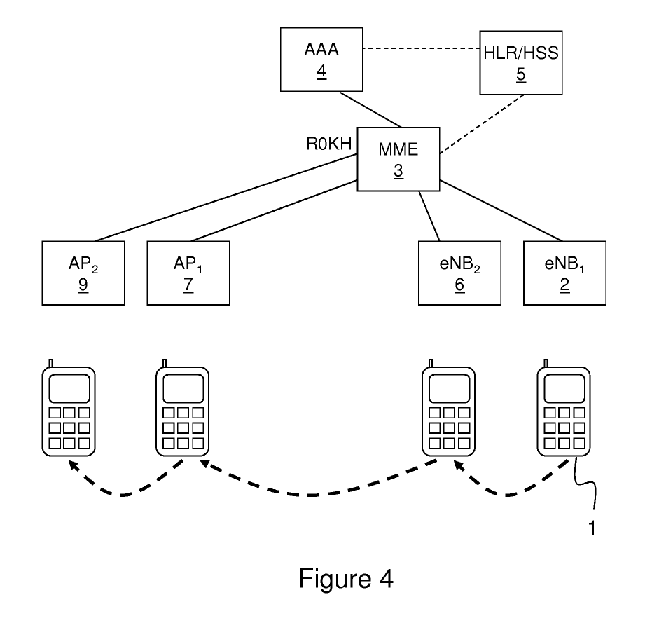

In an alternative embodiment, instead of providing an interface between the R0KH 8 and the MME 3, the MME 3 is used to implement the R0KH functionalities, so the AC 8 need not be involved in the authentication procedure. The network architecture is illustrated in FIG. 4. This is similar to FIG. 3, except that for the purposes of authentication, the MME 3 communicates directly with the APs 7, 9 and acts as the R0 key holder, which the APs remain as R1 key holders. In this situation, there is no need for additional network interface as the MME 3 can directly generate the PTKs for the different APs 7, 9 (the generation of the PMK and transfer from the MME function to the R0KH function is a node-internal matter).

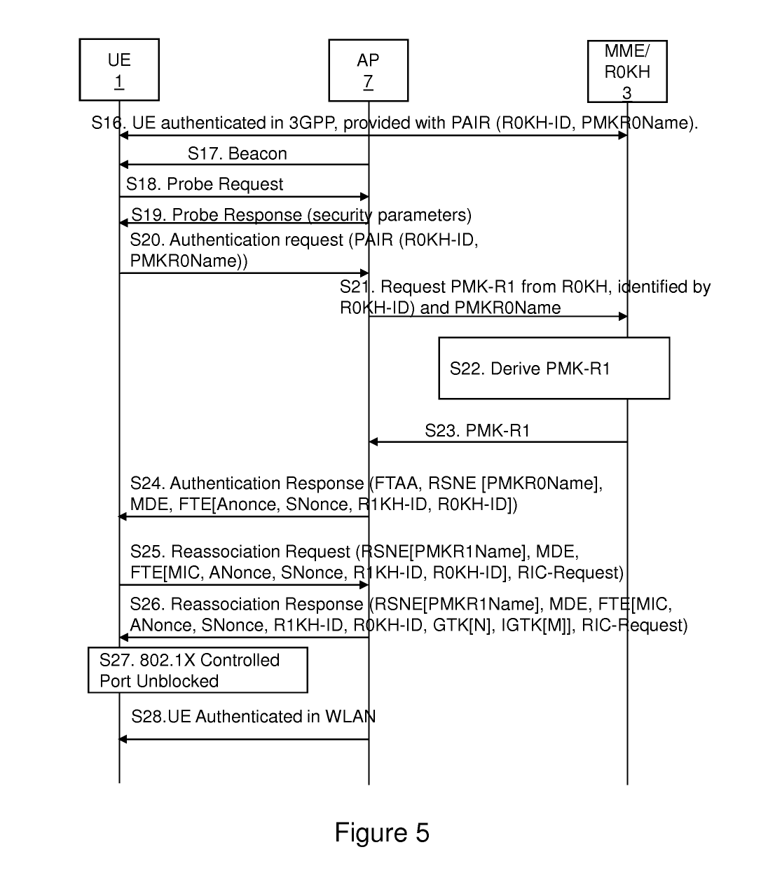

Exemplary signalling is shown in FIG. 5, with the following numbering corresponding to that of FIG. 5:

S16. The mobile device 1 is authenticated in 3GPP. During the authentication process the PAIR (including the PMKR0Name identifying the UE context identifier used in the MME and the R0KH-ID identifying the MME) is provided to the mobile device 1 using the mechanism described in S1.

S17. The mobile device 1 receives a Beacon frame revealing (among other parameters) the security features associated with the ESS the AP 7 belongs to.

S18. If the mobile device 1 does not receive a Beacon frame for some reason, it can generate a Probe Request and send it to the AP 7. This procedure is called active scanning and by performing it, the mobile device 1 receives the same information as it would have from a Beacon message.

S19. The AP 7 responds with a Probe Response.

S20. The mobile device 1 sends an Authentication Request to the target AP 7, the request including the PAIR.

S21. The AP 7 requests the PMK-R1 from the R0KH, identified by the R0KH-ID (as informed by the mobile device 1 in S20). In this case, the R0KH is the MME 3.

S22. The MME 3 derives a PMK-R1 using, for example, PMK and optionally other parameters. The PMK is identified by the PMKR0Name.

S23. The MME 3 provides PMK-R1 to AP 7.

S24. The AP 7 responds to the mobile device 1 with an Authentication Response, indicating the FTAA, the RSNE, the MDE and the FTE (which in this case carries also the Authentication Nonce, ANonce, and the R0KH-ID).

S25. The mobile device 1 then re-associates with the target AP 7 within the allowed Re-association Deadline Time, sending a Re-association Request.

S26. The target AP 7 responds with a Re-association Response.

S27. The 802.1X controlled port is unblocked and the mobile device 1 can successfully transmit (encrypted) data with the target AP 7.

S28. The mobile device 1 transmits data over the WLAN.

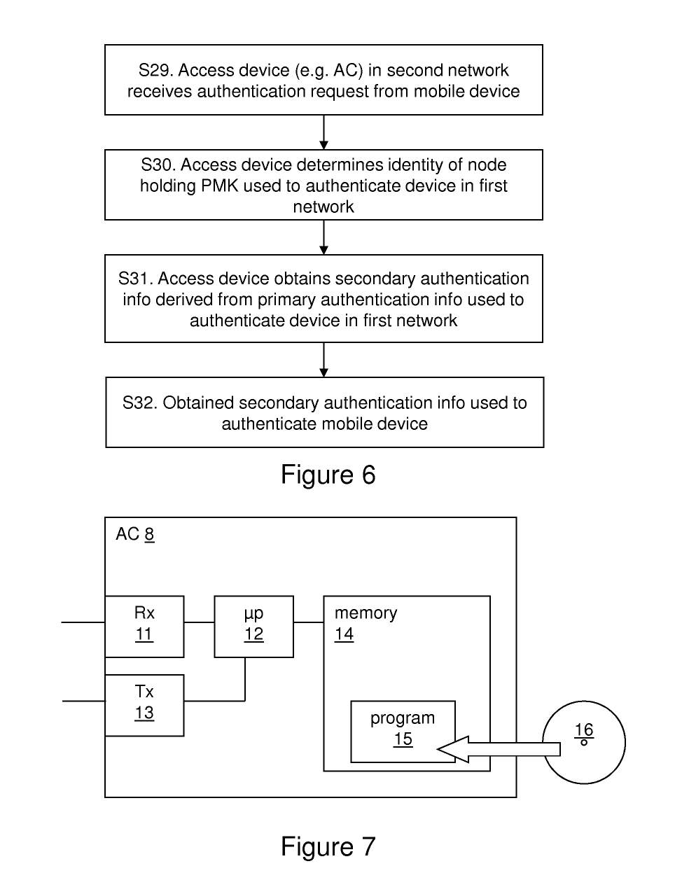

Turning now to FIG. 6, there is shown a flow diagram showing basic steps to authenticate the mobile device 1. The following numbering corresponds to that of FIG. 6:

S29. An access device (such as the AC 8 in the examples above, although it may be the MME 3 where the MME 3 is the R0KH) receives an authentication request from the mobile device 1.

S30. The access device 8 determines the identity of a node where authentication credentials used to authenticate the mobile device in a first mobile access network are contained. The authentication credentials include the PMK used to authenticate the device (the primary authentication information). As described above, the identity of the node may be found using a Locator function 10 or may be explicitly provided by the mobile device 1.

S31. Secondary authentication information is obtained by deriving it from primary authentication information used to authenticate the mobile device in the first mobile access network. This means that the access device that authenticates the mobile device 1 in a second access network (WLAN in this example) requests the secondary authentication information from the node that authenticated the mobile device 1 in the first access network without having to request credentials from the AAA server.

S32. The secondary authentication information is used to authenticate the mobile device in the second access network.

FIG. 7 illustrates an exemplary access device such as an AC 8 or MME 3. In this example, the access device is an AC 8 but it will be appreciated that the same features would be required by an MME 3 or other type of device used in authenticating the mobile device 1.

The access device 8 is provided with a receiver 11 arranged to receive the authentication request from the mobile device. A processor 12 is also provided, along with a transmitter 13 to send messages towards the mobile device 1. The processor 12 is arranged to obtain the secondary authentication information such as PMK1. For example, it may obtain PMK that was used when authenticating the mobile device 1 in a previous network (such as a 3GPP network). The PMK is used to derive PMK1 that is used to authenticate the mobile device 1. The processor 12 may also determine the identity location of a node from which the PMK may be obtained. As described above, this may be by querying a Locator function 10, or the identity may be explicitly provided by the mobile device 1.

The access device 8 is provided with a non-transitory computer readable medium in the form of a memory 14 that can be used for storing a computer program 15 which, when executed by the processor 12, causes the access device 8 to perform the steps shown in FIG. 6. Note that the computer program may be provided using a carrier signal or stored on an external non-transitory computer readable medium 16, such as a flash drive or CD-ROM for loading into the memory 14 or direct execution by the processor 12.

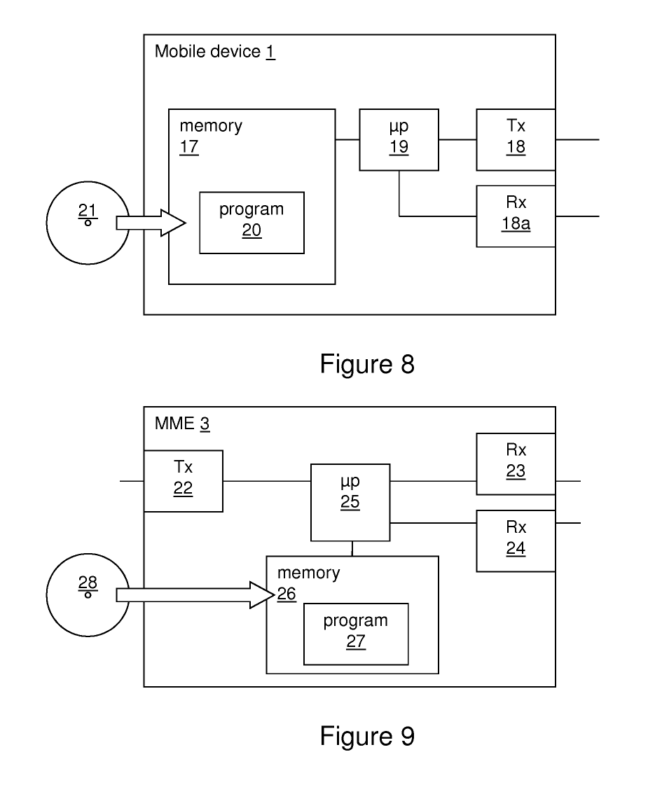

FIG. 8 illustrates an exemplary mobile device 1. The mobile device 1 is provided with a receiver configured to receive information identifying primary authentication information (such as PMK) used to authenticate the mobile device in the first mobile access network. A transmitter is also provided, configured to send a request to the access device 8 to authenticate the mobile device in a second mobile access network.

The request includes information identifying primary authentication information usable by the access device to derive secondary authentication information to authenticate the mobile device in the second mobile access network. A processor may also be provided, configured to, prior to sending the request to the access device, determine that the mobile device is authenticated in the first mobile access network and, as a result, send the request to authenticate the mobile device in the second mobile access network as a re-authentication request.

The mobile device 1 is provided with a non-transitory computer readable medium in the form of a memory 17 that can be used for storing a computer program 20 which, when executed by the processor 19, causes the mobile device 1 to perform the steps described above. Note that the computer program may be provided using a carrier signal or stored on an external non-transitory computer readable medium 21, such as a flash drive or CD-ROM for loading into the memory 17 or direct execution by the processor 19.

FIG. 9 illustrates schematically an access device 3 for use in the first mobile access network with which the mobile device 1 is authenticated. The access device comprises a first transmitter 22 for, during an authentication procedure with the mobile device 1, sending to the mobile device 1 information identifying primary authentication information. A receiver 23 is provided, configured to receive from the further access device 8 located in the second mobile access network a request for secondary authentication information. The request contains the information identifying primary authentication information. A processor 25 is configured to derive the secondary authentication information using the primary authentication information and a second transmitter 24 is provided, configured to send to the further access device 8 the secondary authentication information usable by the further access device to authenticate the mobile device 1 in the second mobile access network.

The access device 3 in the first mobile access network is provided with a non-transitory computer readable medium in the form of a memory 26 that can be used for storing a computer program 27 which, when executed by the processor 25, causes the access device 3 to perform the steps described above. Note that the computer program may be provided using a carrier signal or stored on an external non-transitory computer readable medium 28, such as a flash drive or CD-ROM for loading into the memory 26 or direct execution by the processor 25.

It will be appreciated by the person of skill in the art that various modifications may be made to the above-described embodiments without departing from the scope of the present invention. For example, the above description refers to WLAN and 3GPP access, but it will be appreciated the same techniques can be used when a mobile device attempts to connect to networks using different Radio Access Technologies.

The following abbreviations have been used in the above description:

### 3GPP 3rd Generation Partnership Project

### AAA Authentication, Authorization and Accounting

### AC Access Controller

### AKA Authentication and Key Agreement

### AP Access Point

### AS Access Stratum

### AuC Authentication Centre

AV authentication vector

### DNS Domain Name System

### DRB Data Radio Bearer

### EAP Extensible Authentication Protocol

eNB eNodeB

### GTK Group Temporal Key

### GUMMEI Globally Unique MME Identifier

### GUTI Globally Unique Temporary UE Identity

### HLR Home Location Register

### HSS Home Subscriber Server

### IMSI International Mobile Subscriber Identity

### LTE Long Term Evolution

### MME Mobility Management Entity

### MMEC MME Code

### MMEGI MME Group ID

### MMEI MME Identifier

### NAS Non-Access Stratum

### NH Next Hop

### NCC Next Hop Chaining Counter

### PMK Pairwise Master Key

### PTK Pairwise Temporal Key

### RBS Radio Base Station

### RRC Radio Resource Control

### SMS Short Message Service

### SRB Signalling Radio Bearer

### STA Station

### S-TMSI S-Temporary Mobile Subscriber Identity

### UE User Equipment

### USIM Universal Subscriber Identity Module

### WLAN Wireless Local Area Network

1. A method of authenticating a mobile device in a second mobile access network, the mobile device being authenticated in a first mobile access network, the method comprising:
receiving, at an access device, an authentication request from the mobile device;
the access device obtaining secondary authentication information derived from primary authentication information used in an authentication procedure to authenticate the mobile device with the first mobile access network;
using the secondary authentication information to authenticate the mobile device in the second mobile access network.

2. The method of claim 1, wherein the first mobile access network comprises a 3GPP network and the second mobile access network comprises a Wireless Local Area Network.

3. The method of claim 1, wherein the access device is an R0 Key Holder.

4. The method of claim 3 wherein the R0 Key Holder is located in any of the first and second mobile access networks.

5. The method of claim 1, wherein the primary authentication information comprises a Pairwise Master Key.

6. The method of claim 5, further comprising deriving a second Pairwise Master Key for use in authenticating the mobile device in the second mobile access network.

7. The method of claim 6, wherein the second Pairwise Master Key is usable to derive a Pairwise Temporal Key, the Pairwise Temporal Key being usable by the mobile device to perform an encryption operation on communications sent between the mobile device and the second mobile access network.

8. The method of claim 1, further comprising, receiving in the authentication request information identifying the primary authentication information and determining the identity of a further access device from which the secondary authentication information can be obtained.

9. The method of claim 8, further comprising sending to the further access device the received information identifying the primary authentication information.

10. The method of claim 8, wherein the identity of the further access device is determined by any of querying a location function storing an identity of the further device using an identity of the mobile device, and receiving information identifying the primary authentication information in the authentication request identifying the further access control device.

11. The method of claim 1, further comprising performing authentication in the second mobile access network using a fast re-authentication procedure.

12. An access device arranged to authenticate a mobile device in a network, the mobile device being authenticated in a first mobile access network, the access device comprising:
a receiver operable to receive an authentication request from the mobile device; and
a processor configured to obtain secondary authentication information derived from primary authentication used in an authentication procedure to authenticate the mobile device with the first mobile access network, wherein
the processor is further configured to authenticate the mobile device in the network using the obtained secondary authentication information.

13. The access device of claim 12, wherein the first mobile access network comprises a 3GPP network and the network comprises a Wireless Local Area Network.

14. The access device of claim 13, wherein the access device is an R0 Key Holder.

15. The access device of claim 12, wherein the primary authentication information comprises a Pairwise Master Key.

16. The access device of claim 15, wherein the processor is further arranged to derive a second Pairwise Master Key for use in authenticating the mobile device in the network.

17. The access device of claims 12 to 16 of claim 12, wherein the processor is arranged to determine from the authentication request information identifying the primary authentication information, and subsequently determine an identity location of a further access device from which the secondary authentication information can be obtained.

18. The access device of claim 17, further comprising a transmitter arranged to send to the further access device the received information identifying the primary authentication information.

19. The access device of claim 17, wherein processor is further arranged to determine the location of the further access control device by any of querying a location function storing an identity of the further device using an identity of the mobile device, and receiving information in the authentication request identifying the further access control device.

20. A mobile device for use in a communication network, the mobile device comprising:
a receiver operable to receive information identifying primary authentication information used to authenticate the mobile device in a first mobile access network;
a transmitter; and
a processor configured to employ the transmitter to send a request to an access device to authenticate the mobile device in a second mobile access network, the request including information identifying primary authentication information usable by the access device to derive secondary authentication information to authenticate the mobile device in the second mobile access network.

21. The mobile device of claim 20, wherein the processor is further arranged to, prior to sending the request to the access device, determine that the mobile device is authenticated in the first mobile access network and, as a result, send the request to authenticate the mobile device in the second mobile access network as a re-authentication request.

22. An access device for use in a first mobile access network with which a mobile device is authenticated, the access device comprising:
a first transmitter for, during an authentication procedure with the mobile device, sending to the mobile device information identifying primary authentication information; and
a receiver for receiving from a further access device located in a second mobile access network a request for secondary authentication information, the request containing the information identifying primary authentication information;
a processor configured to derive the secondary authentication information using the primary authentication information; and
a second transmitter for sending to the further access device the secondary authentication information usable by the further access device to authenticate the mobile device in the second mobile access network.

23. A computer program product comprising a non-transitory computer readable medium storing a computer program comprising computer readable code which, when run on an access device, causes the access device to perform the method of claim 1.

24. A computer program product comprising a non-transitory computer readable medium storing a computer program comprising computer readable code which, when run on a mobile device, causes the mobile device to send a request to an access device to authenticate the mobile device in a second mobile access network, the request including information identifying primary authentication information used to authenticate the mobile device in a first mobile access network and usable by the access device to derive secondary authentication information to authenticate the mobile device in the second mobile access network.

25. A computer program product comprising a non-transitory computer readable medium storing a computer program comprising computer readable code which, when run on an access device in a first mobile access network with which a mobile device is authenticated, causes the access device to send to the mobile device information identifying primary authentication information and, in response to a request from a further access device in a second mobile access network, derive secondary authentication information using the primary authentication information and send to the further access device the derived secondary authentication information, the secondary authentication information usable by the further access device to authenticate the mobile device in the second mobile access network.

26. (canceled)
